(19) United States
(12) Patent Application Publication
(10) Pub. No.: US 2020/0211170 A1
(43) Pub. Date: Jul. 2, 2020

(54) LIVE VIEWFINDER VERIFICATION OF IMAGE VIABILITY

(71) Applicant: Wiivv Wearables Company, San Diego, CA (US)

(72) Inventors: Lino Evgueni Coria Mendoza, Port Moody, CA (US); Myat Thu, Burnaby, CA (US); Hsiao Ting Lin, Coquitlam, CA (US); Timothy Vander Wekken, Vancouver, CA (US); Leonardo Campopiano Nakashima, Vancouver, CA (US); Ho Fai Wong, New Westminster, CA (US); Colin M. Lawson, Calgary, CA (US); Shamil M. Hargovan, San Jose, CA (US); Qianyu Gao, Vancouver, CA (US); Halley Chung, Richmond, CA (US)

(21) Appl. No.: 16/290,767

(22) Filed: Mar. 1, 2019

Related U.S. Application Data
(60) Provisional application No. 62/786,087, filed on Dec. 28, 2018.

(51) Int. Cl. G06T 7/00; G06T 19/20; G06T 17/20; G06K 9/00

(52) U.S. Cl. CPC G06T 7/0002; G06T 19/20; G06K 9/00744; G06K 9/00362; G06T 17/20

(57) ABSTRACT

Disclosed is a user input verification technique for use in generating and delivering 3-D printed wearables. Users take photos of parts of their body as input into a custom wearable generation application. The body photos are subjected to a precise computer vision (CV) process to determine specific measurements of the user's body. To reduce the incidence of poor input data, image data is automatically taken from the camera viewfinder prior to the user issuing an image capture command. The extracted viewfinder data is subjected to an abbreviated CV process in order to determine viability for the precise CV process.

### CROSS-REFERENCE TO RELATED APPLICATIONS

This application claims the benefit of U.S. Provisional Patent Application Ser. No. 62/786,087, filed Dec. 28, 2018, which is incorporated by reference herein in its entirety.

### TECHNICAL FIELD

This disclosure relates to 3-D digital modeling and, more particularly, to input and output handling of image data to generate 3-D models.

### BACKGROUND

People tend to like products that are customized for them more than generic products. Depending on the nature of the product, customization can be based on photographs or other self-collected image data of some source material that a customized item is intended to fit. Where data input for customization is generated by or at the direction of a user, input data will often be insufficient due to user error. Insufficient image data may lead to poor quality in customized items and may cause a reduction in user confidence or the necessity of additional customer service interactions. It is therefore important to ensure sufficiency of input data in a process of producing customized products.

### BRIEF DESCRIPTION OF THE DRAWINGS

FIG. 1 is a block diagram illustrating a system for the generation of customized 3D printed wearables.

FIG. 2 is a flowchart illustrating a process for generating custom 3D printed wearables.

FIG. 3 is a flowchart illustrating a process for validating images of the user to be used in creating a customized 3D printed wearable.

FIG. 4 is a flowchart illustrating a process by which the mobile device interacts with the user to acquire images of the user.

FIG. 5 is a flowchart illustrating a process for performing computer vision on collected images of a user.

FIG. 6 is an illustration of a coordinate graph including a collection of X,Y locations along a body curve.

FIG. 7 is a block diagram illustrating a distributed system for the generation of customized 3D printed wearables.

FIG. 8 is a flowchart illustrating wearable generation including simultaneous computer vision and machine learning processes.

### DETAILED DESCRIPTION

By using computer vision techniques, digital models (3-D and/or 2-D) can be constructed for objects found in image data. The digital models subsequently can be used for numerous activities, including generation of 3-D printed objects sized and shaped to match the objects found in the image data. For example, in some embodiments, images of a human body are used to model at least a portion of the human body, and then customized wearables can be printed for the modeled portion of the human body (e.g., footwear, headwear, undergarments, etc.). Depending on the subject object (e.g., body part), the image data includes particular views of that object and key points on that object. In order to accurately model the subject of the image data, it is important to obtain good images of the subject.

In some embodiments, users are directed to use a mobile device, such as a smartphone including a camera, to take photos of some subject object (e.g., their feet). Because users are controlling the capture of the photo of the subject object, the input image data is prone to be of poor quality. Even well-intentioned users make mistakes or do not wish to take sufficient time to learn proper technique to capture usable images. The capture software should therefore be able to direct the user in the process of capturing suitable images. Additionally, the ease of user experience is important. Users can get easily frustrated with instructions that are complex or not intuitive or that seem to direct the user in circles. For example, capturing image data and then telling the user that the image is of poor quality and therefore needs to be captured again may be frustrating for some users. To facilitate ease of use and user experience, it is desirable that suitable quality images are captured the first time through.

In order to improve the likelihood that suitable images are captured in the first attempt, direction can be given to users in the picture capture phase, for example, on the camera viewfinder (e.g., the display of a smartphone when the smartphone is operating in camera mode). In order to give useful direction on the viewfinder, image data is pulled from the image sensor of the camera in real-time (e.g., what the user sees in the viewfinder), the image data is subjected to a quality inspection in real-time, and feedback is displayed on the viewfinder.

To generate 3D printed wearable objects (“wearables”) with simple user instructions and minimal processing, the technique introduced here enables commonly available mobile devices to be used to image the prospective wearer and enables a processing server or distributed set of servers to use the resulting images to generate a tessellation model. The tessellation model can then be used to generate a 3D printed wearable object (hereinafter simply “wearable”). The term “wearable” as used herein refers to articles, adornments or items designed to be worn by a user, incorporated into another item worn by a user, acting as an orthosis for the user, or interfacing with the contours of a user's body. An example of a wearable used throughout this disclosure to facilitate description is a shoe insole. A shoe insole is illustrative in that the shape and style of insole that one particular person would want/need over the shape and style that another person would want/need tend to vary greatly across people, such that customization is important. Nonetheless, the teachings in this disclosure apply similarly to other types of wearables, such as bracelets, rings, brassiere, helmets, earphones, goggles, support braces (e.g., knee, wrist), gauge earrings, and body-contoured peripherals.

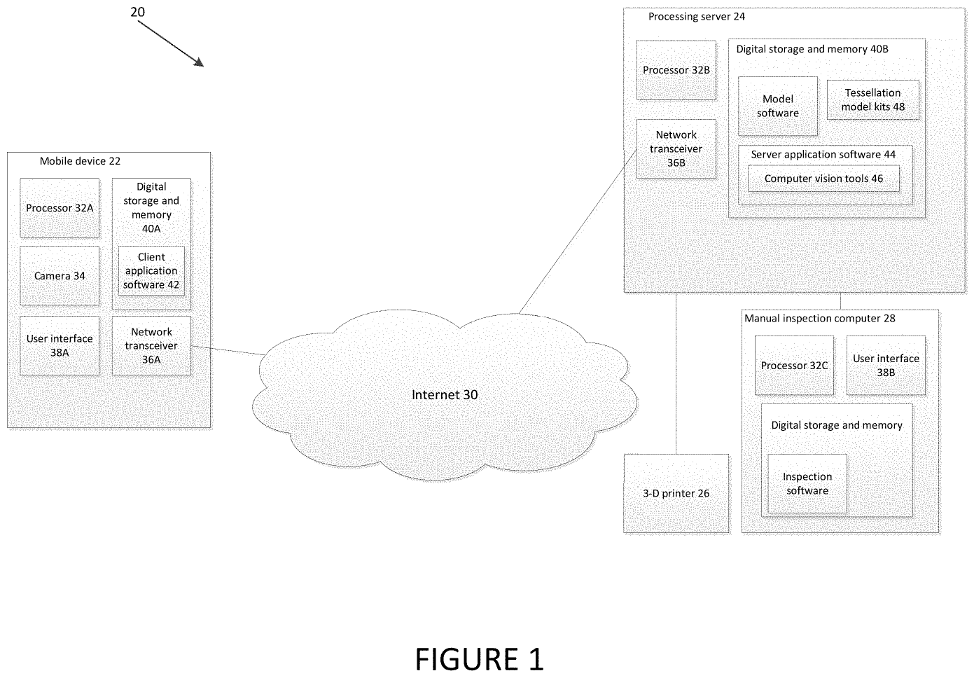

FIG. 1 is a block diagram illustrating a system 20 for the generation of customized 3D printed wearables. Included in the system 20 is the capability for providing body part input data. Provided as a first example of such a capability in FIG. 1 is a mobile processing device (hereafter, “mobile device”) 22 that includes a digital camera 34 and is equipped to communicate over wireless network, such as a smartphone, tablet computer, a networked digital camera or other suitable known mobile devices in the art; a processing server 24; and a 3D printer 26. The system further can include a manual inspection computer 28.

The mobile device 22 is a device that is capable of capturing and transmitting images over a network, such as the Internet 30. In practice, a number of mobile devices 22 can be used. In some embodiments, mobile device 22 is a handheld device. Examples of mobile device 22 include a smart phone (e.g., Apple iPhone, Samsung Galaxy), a confocal microscopy body scanner, an infrared camera, an ultrasound camera, a digital camera, and tablet computer (e.g., Apple iPad or Dell Venture 10 7000). The mobile device 22 is a processor enabled device including a camera 34, a network transceiver 36A, a user interface 38A, and digital storage and memory 40A containing client application software 42.

The camera 34 on the mobile device may be a simple digital camera or a more complex 3D camera, scanning device, InfraRed device, or video capture device. Examples of 3D cameras include Intel RealSense cameras or Lytro light field cameras. Further examples of complex cameras may include scanners developed by TOM-CAT Solutions, LLC (the TOM-CAT, or iTOM-CAT), adapted versions of infrared cameras, ultrasound cameras, or adapted versions of intra-oral scanners by 3Shape.

Simple digital cameras (including no sensors beyond 2-D optical) use reference objects of known size to calculate distances within images. Use of a 3D camera may reduce or eliminate the need for a reference object because 3D cameras are capable of calculating distances within a given image without any predetermined sizes/distances in the images.

The mobile device also provides a user interface 38A that is used in connection with the client application software 42. The client application software 42 provides the user with the ability to select various 3D printed wearable products. The selection of products corresponds with camera instructions for images that the user is to capture. Captured images are delivered over the Internet 30 to the processing server 24.

Processer 32B controls the overall operation of processing server 24. The processing server 24 receives image data from the mobile device 22. Using the image data, server application software 44 performs image processing, machine learning and computer vision operations that populate characteristics of the user. The server application software 44 includes computer vision tools 46 to aid in the performance of computer vision operations. Examples of computer vision tools 46 include OpenCV or SimpleCV, though other suitable examples are known in the art and may be programmed to identify pixel variations in digital images. Pixel variation data is implemented as taught herein to produce desired results.

In some embodiments, a user or administrative user may perform manual checks and/or edits to the results of the computer vision operations. The manual checks are performed on the manual inspection computer 28 or at a terminal that accesses processing server 24's resources. The processing server 24 includes a number of premade tessellation model kits 48 corresponding to products that the user selects from the client application software 42. Edits may affect both functional and cosmetic details of the wearable—such edits can include looseness/tightness, and high rise/low rise fit. Edits are further stored by the processing server 24 as observations to improve machine learning algorithms.

In some embodiments, the tessellation model kits 48 are used as a starting point from which the processing server 24 applies customizations. Tessellation model kits 48 are a collection of data files that can be used to digitally render an object for 3D printing and to print the object using the 3D printer 26. Common file types of tessellation model kits 48 include .3dm, .3ds, .blend, .bvh, .c4d, .dae, .dds, .dxf, .fbx, .lwo, .lws, .max, .mtl, .obj, .skp, .stl, .tga, or other suitable file types known in the art. The customizations generate a file for use with a 3D printer. The processing server 24 is in communication with the 3D printer 26 in order to print out the user's desired 3D wearable. In some embodiments, tessellation files 48 are generated on the fly from the input provided to the system. The tessellation file 48 is instead generated without premade input through an image processing, computer vision, and machine learning process.

Numerous models of 3D printer 26 may be used by the invented system. 3D printers 26 vary in size of printed article. Based on the type of 3D wearable users are selecting, varying sizes of 3D printer 26 are appropriate. In the case where the 3D wearable is a bracelet, for example, a six-cubic inch printer may be sufficient. When printing shoe insoles, however, a larger printer may be required. A majority of insoles can be printed with a 1 cubic foot printer.

Users of the system may take a number of roles. Some users may be administrators, some may be the intended wearer of an end, 3-D printed product, some users may facilitate obtaining input data for the system, and some may be agents working on behalf of any of user type previously mentioned.

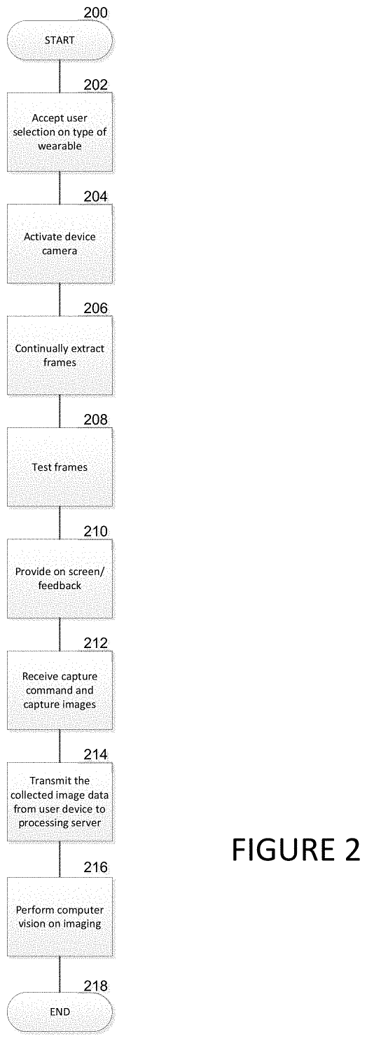

FIG. 2 is a flowchart illustrating a process for generating custom 3D printed wearables. In step 202, the mobile device accepts input from a user through its user interface, concerning the selection of the type of wearable the user wants to purchase. In some embodiments, the mobile device uses a mobile application, or an application program interface (“API”) that includes an appropriate user interface and enables communication between the mobile device and external web servers. Wearable examples previously mentioned include shoe insoles, bracelets, rings, brassiere, and gauge earrings. In addition to these examples, the product may categorize further into subclasses of wearables. Among shoe insoles, for example, there can be dress shoe, athletic shoe, walking shoe, and other suitable insoles known in the art. Each subclass of wearable can have construction variations.

In addition to choosing the wearable type and subclass, the user enters account information such as payment and delivery address information. Some embodiments include social features by which the user is enabled to post the results of a 3D wearable customization process to a social network.

In step 204, the mobile device activates its respective camera function. The application software provides instructions to the user to operate the camera to capture images of the user (or more precisely, a body part of the user) in a manner which collects the data necessary to provide a customized wearable for that user.

In step 206, the application software collects image data from the camera without further user instruction or input. The image data uses real-time frames taken from the output of the image sensor, without any capture input from the user. Step 206 is performed multiple times extracting multiple frames.

In step 208, the frames extracted in step 206 are tested for suitability for generation of a model of the relevant portion of the user's body. In some embodiments the test is performed locally on the mobile device, using the mobile device's processor. In such embodiments the suitability test may have smaller memory/storage requirements than a more-thorough computer vision analysis performed on image data on the backend/application server. A large machine learning model may be a deterrent from users installing the application. Whether an application is “large” is a function of the total size of the mobile device's memory or storage space as compared to the size of the application. “Large” may be a function of the percentage of the total space available. At the time of writing, an application that requires over half of a percent of total storage space may be considered large. The percentage may change over time as average storage space on devices becomes more plentiful.

Examples of features tested in various embodiments include: whether or not the expected body part is present in frame, whether all of the expected body part is in frame, whether used reference objects appear in frame, whether used reference objects have the expected dimensions (e.g., the ratio of the size of one side as compared to another, expected angles at corners, etc.). For some determinations trained models that recognize body parts are used. For some determinations, dimensions of groups of pixels are compared without use of a trained model. In some embodiments the test is performed in real-time via an API that runs pre-trained machine learning models.

In step 210, where a given frame fails the test, the application causes instructions/feedback to appear on screen that help the user to adjust the camera position to capture a better image. Feedback to the user might include information on what is wrong with the current setting and what to do to avoid this problem (for example: “part of your foot is missing, please move away from your phone,” or “image is too dark, consider moving to a brighter location”). In some embodiments, feedback may be further based on the accelerometer and gyroscope that act to create a levelling system for the camera. In step 212, the application captures an image for use by the application server. In some embodiments the image is captured based on user command or lack of user intervention when supplied with a GUI indicator that image data is about to be captured. In some embodiments, the image used in further processing to generate the wearable is captured without user direction.

In step 214, the mobile device transmits the captured image data to the processing server 24. In step 216, the processing server performs computer vision operations on the image data to determine the size, shape, and curvature of the user (or body part of the user), where applicable to the chosen product type.

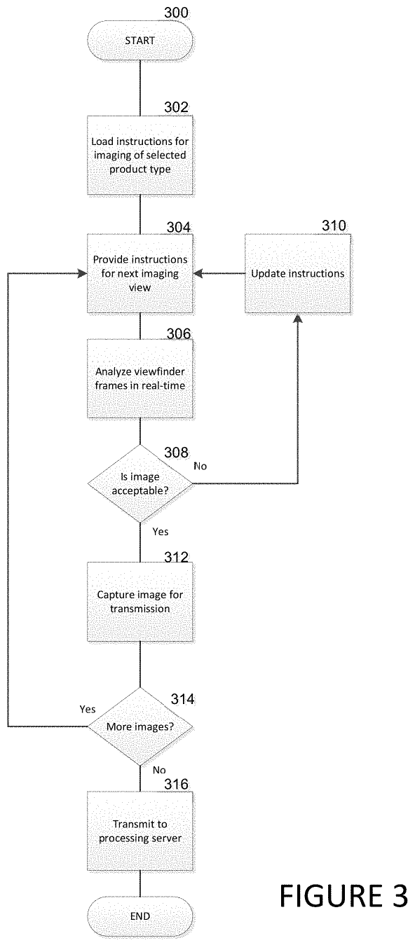

FIG. 3 is a flowchart illustrating a process for acquiring verified images of the user to be used in creating a customized 3D printed wearable. In step 302, the client application software on the mobile device loads (e.g., from local or remote memory) the necessary instructions to guide the user to capture body images for the wearable type and subclass selected. The instructions properly direct a user to capture image data of the user's body part or parts as applicable to the wearable type.

In step 304, the loaded instructions are provided to the user via the mobile device's user interface (e.g., via a touchscreen and/or audio speaker) to facilitate image data capture. The body part imaging may involve acquiring multiple images. The images required may depend on the kind of mobile device used and/or the wearable type selected. The instructions provided to the user can include details such as the orientation of the camera and the objects/body parts that should be in frame of the camera's view finder. Additional examples of instructions may include moving the camera in any combination of the six degrees of freedom (i.e., translation and/or rotation in any of three orthogonal coordinate axes).

In step 306, the application collects frames from the camera's image sensor in real-time. The frames are those that are currently being displayed through the mobile device's viewfinder and are therefore referred to herein as “viewfinder frames” to facilitate explanation. The frames include body part image data and may exist in any of various formats, such as 2D images, 3D images, and body scanner imaging data. In some embodiments, the body part image data may come from an 3D image sensing apparatus (such as a body scanner from a doctor's office).

In step 308, the client application software performs validation on the viewfinder frames. In some embodiments, the validation is performed by an API. The validation may use object and pixel recognition software incorporated into either the client software or API calls to determine whether or not a viewfinder frames are acceptable. Validation is performed using at least one of a number of types of analyses including: trained model comparison, bounds identification, angle estimation, and ratio estimation. Trained model comparisons can be used to perform object recognition.

For example, if the image is expected to be of the user's foot in a particular orientation, an image of a dog can be recognized as unacceptable based on expected variations in pixel color. The trained model identifies the content of the real-time viewfinder data as either “a foot” or “not a foot.” Further validation identifies whether the object (a foot) is positioned correctly in frame.

Bounds identification, angle estimation, and ratio estimation can be used to determine whether more subtle errors exist. For example, where a reference object is used in frame, and the expected reference object is a sheet of 8.5″×11″ paper, if the paper is identified as non-rectangular, there is an issue with the reference object. That issue may be that the sheet of paper has become damaged in some manner. The angles of the corners of the paper as well as the relative lengths of the edges can be used to determine whether the real-time image frames are valid for further processing.

The validation of step 308 is a light-weight test of the frames. That is, the analysis is performed with low computational cost and uses a relatively low amount of storage space on the camera device. A low computational cost is one that completes a validation of a given frame as quickly as the human eye can parse information. Step 308 is performed repeatedly across numerous frames. In some embodiments, the validation occurs quickly enough to complete and present the user with feedback regarding the validation in a manner that presently smoothly to the eye.

In the case of an unacceptable image (“failed frame”), in step 310, the current frame data is deleted or archived, and based on the manner that the frame failed feedback is provided via the GUI. Feedback to the user might include information on what is wrong with the current setting and what to do to avoid this problem (for example: “part of your foot is missing from the frame, please move away from your phone,” or “image is too dark, consider moving to a brighter location”). In some embodiments, feedback may be further based on the accelerometer and gyroscope which acts to create a levelling system for the camera. The feedback provided for a failed frame is based on the manner in which the frame failed and at what step in the validation failure occurred.

For example, if the wrong body part is in frame, the feedback is to place the correct body part in frame. If the correct body part is in frame, but it is shifted, then the feedback is to shift the camera to obtain positioning. If the correct body part is in frame, but the wrong side/surface is presented, then the feedback suggests altering the perspective of the camera to obtain the correct surface. Any of the disclosed criteria may be used as a basis for a determination of image suitability.

Feedback can appear on screen as text, graphical, and/or audible instructions. Steps 304 through 310 iterate repeatedly. When a frame is validated, the process moves on to step 312. In some embodiments, steps 304 through 310 continue to iterate even after a given frame is validated. The continuous validation process is conducted because the user may not hold their camera steady or move after a frame is validated.

In step 312, the application software captures an image that persists in memory beyond the validation process. In some embodiments, step 312 is triggered by user input such as a capture command. In some embodiments, the capture of an image for transmission is performed automatically after successfully validating step 308. In some embodiments, multiple images of a given body part are used to develop a model of the body. In such circumstances, in step 314, the application determines if any additional images are required of the specified body part.

In step 316, the wearable data collected is transmitted by the mobile device to the processing server.

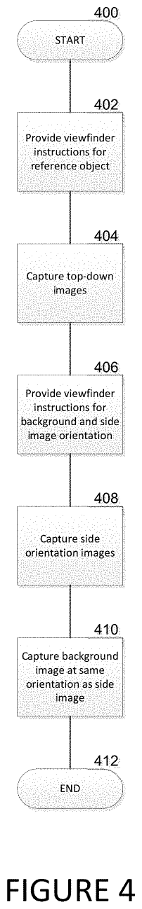

FIG. 4 is a flowchart illustrating a process by which the mobile device interacts with the user to acquire images of the user. In some embodiments, particular image data is used, and multiple images may be requested. In the shoe insole example, where the user wishes to purchase insoles for both feet, five photos of image data for each pair of insoles to be fabricated may be requested (e.g., two images of the top of each of the user's feet, and two of the inner side of each of the user's foot). Where the user wishes to obtain only a single insole, three images are used. The system does not take the images from the foot that will not serve to model a custom insole. In some embodiments, the system uses a background image of the space behind the side images, without the user's foot.

In step 402, the mobile device provides the user with instructions for the top down views. In some embodiments, where a non-3D camera is used, the instructions include a reference object. In some embodiments, the reference object is a piece of standard-sized paper, such as letter-size (e.g., 8.5×11 inch) or A4 size. Because such paper has well-known dimensions and is commonly available in almost every home, it can be used as a convenient reference object. Based on length versus width proportions of the paper, the application software can determine automatically whether the paper is letter sized, legal size, A4 sized, or other suitable standardized sizes. Based on the style of the paper, the application software has dimensions of known size within a frame of the image. In other embodiments, the user may be asked to indicate or confirm the paper size chosen via the user interface (e.g., letter-size or A4).

The instructions for the top down image direct the user to find an open floor space on a hard, flat surface (such as wood or tile) in order to avoid warping the paper, thereby casing errors in the predetermined sizes. The user is instructed to place the paper flush against a wall, stand on the paper and aim the mobile device downward towards the top of the user's foot.

In some embodiments, there is additional instruction to put a fold in the paper such that when placed flush with the wall, the paper does not slide under molding or other wall adornments. Additionally, the mobile device user interface includes a level or orientation instruction which is provided by an accelerometer or gyroscope onboard the mobile device. The level shows the user the acceptable angle at which image data is captured.

In some embodiments, no reference object is necessary. Where the mobile device includes two cameras, parallax distance measurement between two photographs may be used to determine a known distance and therefore calculate sizes of the body part. In some cases, it is preferable to perform a number of parallax distance measurements to different points between the two photographs in order to find comparative distances between those points enabling derivation of additional angular data between the two photographs. Similarly with the reference object, once the image has a first known distance, other sizes within the image (such as the shape of body parts) may be calculated with mathematical techniques known in the art.

Where a single camera is used, additional sensors are utilized to provide data as necessary. The camera used in conjunction with an accelerometer, gyroscope, or inertial measurement unit (“IMU”), enables a similar effect as where there are two cameras. After the first image is taken, the camera is moved, and the relative movement from the first position is tracked by the IMU. The camera then takes a second image. Given information from the IMU the parallax angle between where the first image was captured, and the second image can be calculated via stereoscopy. Directions may be provided via the viewfinder regarding the positioning of the stereoscopic images based an analysis of real-time image sensor frames.

The method may be performed with a video clip instead. While the video clip is captured, the IMU tracks the movement of the mobile device relative to a first location. Time stamps between the video clip and the IMU tracking are matched up to identify single frames as static images, the parallax angle between each is solvable and the distance to objects in the images are identifiable. In some embodiments, the video clip is an uninterrupted clip. The uninterrupted clip may pass around the body part. The video clip is mined for frames suitable to use as image data.

In step 404, the mobile device captures images of the user's foot from the top down. Reference is made to the use of a single foot; despite this, this process is repeated for each foot that the user wishes to purchase an insole for. Later, during image processing, computer vision, and machine learning operations on the processing server, the top down images are used to determine the length and width of the foot (at more than one location). Example locations for determining length and width include heel to big toe, heel to little toe, joint of big toe horizontally across, and distance from either side of the first to fifth metatarsal bones. An additional detail collected from the top down view is the skin tone of the user's foot.

In step 406, the mobile application or API provides the user with directions to collect image data for the inner sides of the user's foot. This image is used to later process the curvature of the foot arch. The mobile application or API instructs the user to place the mobile device up against a wall and then place a foot into a shaded region of the viewfinder. Based upon predetermined specifications of the model of mobile device being used, and the orientation of the mobile device (indicated by onboard sensors) the application knows the height of the camera from the floor. Using a known model of mobile device provides a known or expected height for the camera lens.

In step 408, the mobile device captures images of the inner side of the user's foot. Later, during computer vision operations on the processing server, the inner side images are mapped for the curvature of the user's foot arch. Using pixel color differences from the background and the foot, the computer vision process identifies a number of points (e.g., 100) from the beginning of the arch to the end. In some embodiments, the server application software uses the skin tone captured from the top down images to aid the computer vision process to identify the foot from the background.

In some embodiments, additional images of the base of the user's foot are also taken. The server application software uses these photos to determine the depth of the user's foot arch. Without the base image data, the depth of the user's foot arch is estimated based on the height of the foot arch as derived from the inner foot side photos.

In step 410, the mobile device provides instructions to take an image matching the inner side foot photos, only without a foot. This image aids the computer vision process in differentiating between the background of the image and the foot from prior images. With some a predetermined degree of error tolerance, the difference between the inner side images and the background images should only be the lack of a foot, thus anything in both images would not be the user's foot.

The example in FIG. 4 concerning a user's foot is intended to be illustrative. Many different body parts can be imaged with similarly acquired sets of photographs/media, which may vary in angle and/or number based on the body part.

Using a mobile device, users capture video or a series of images of objects including body parts (feet, hands, head, etc.). The system analyses the real time video stream on the mobile device using computer vision on frames extracted multiple times per second from an image sensor feed used for a camera viewfinder. The system automatically determines whether the extracted frames are suitable for determining features of the relevant body part required to produce a custom product. Where the relevant body parts are feet, the system may produce custom wearable products such as insoles, sandals and other footwear.

The system combines input from embedded device sensors and any available features of the device camera in the analysis of the video frames in determining the desired object is in the frame. The sensors involved are the accelerometer and gyroscope which acts to create a levelling system so ensure the image captured is not warped and correct dimensions of the object can be determined later.

The system is also able to utilize depth sensing cameras when available on a mobile device to extract information regarding estimated distances and estimated length of the body part in question to offer feedback to the user with information regarding the scanned body part with useful information which will/can be used to produce the custom product.

The viewfinder provides feedback in real time to the user regarding the quality/usefulness of the frames from the real-time video stream. By providing feedback, the user is able to reposition his or her body part (e.g., feet) before the images used for wearable development are captured. Once the user is informed that the correct image is in the frame, the camera can take an image automatically. The feedback is provided by the system once the probability of the object being in the frame is high. For the case of a human foot, the system would determine that the entirety of the foot is visible from one or many angles. For example, there could be two views relevant for feet: a top view image of the foot which shows all the toes and a side view image of the foot, which shows the foot's arch curve.

Feedback to the user might include information on what is wrong with the current setting and what to do to avoid this problem (example: “part of your foot is missing, please move away from your phone” or “image is too dark, consider moving to a brighter location”). Once the images are captured, the images are used to identify the size and shape of the body part as well as any other anatomical features necessary to create a custom wearable product.

In some embodiments, image testing is performed in real-time via an API that runs pre-trained machine learning models. In another implementation, the pre-trained model is self-contained within the app and there is no need to use an API.

In some embodiments, the image analysis estimates size the ratio of various elements of the image by having a reference object photographed next to the object of interest. Alternatively, multiple stereo images may be used to determine ratio of elements of the object of interest.

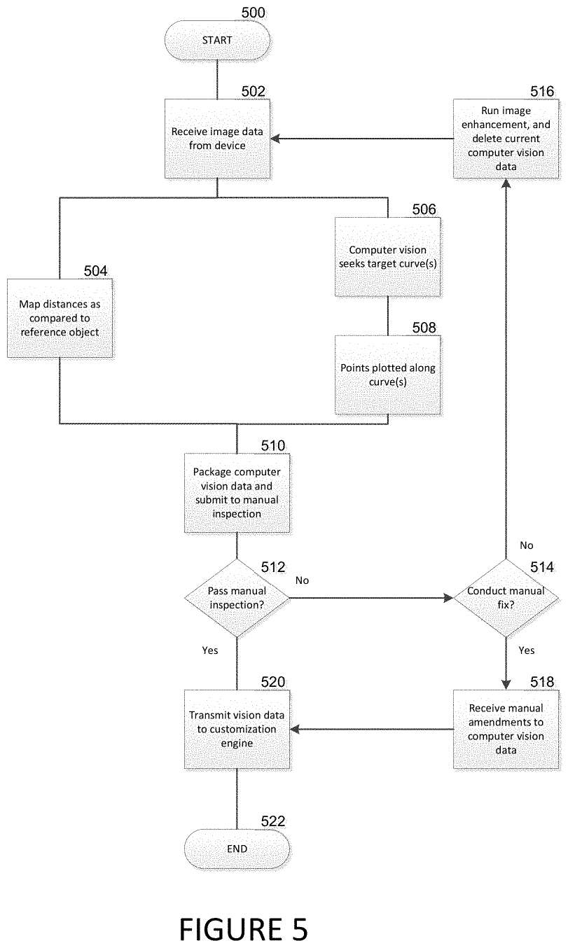

FIG. 5 is a flowchart illustrating a process for performing computer vision on collected user images in order to generate size and curvature specifications. FIG. 5 is directed to the example of a foot, though other body parts work similarly. The curves of each body part vary, the foot in this example is a complex, curved body structure. The steps of FIG. 5 in at least some embodiments are all performed by the server application software. In step 502, the processing server receives image data from the mobile device. Once received, in step 504 and 506, the processing server performs computer vision operations on the acquired image data to determine size and curvature specifications for the user's applicable body part.

In step 504, the server application software analyzes the image data to determine distances between known points or objects on the subject's body part. Example distances include heel to big toe, heel to little toe, joint of big toe horizontally across, and distance from either side of the first to fifth metatarsal bones. This process entails using predetermined or calculable distances based on a reference object or calculated distances with knowledge of camera movement to provide a known distance (and angle). In some embodiments, the reference object can be a piece of standard size paper (such as 8.5″×11″), as mentioned above. The application software then uses known distances to calculate unknown distances associated with the user's body part based on the image.

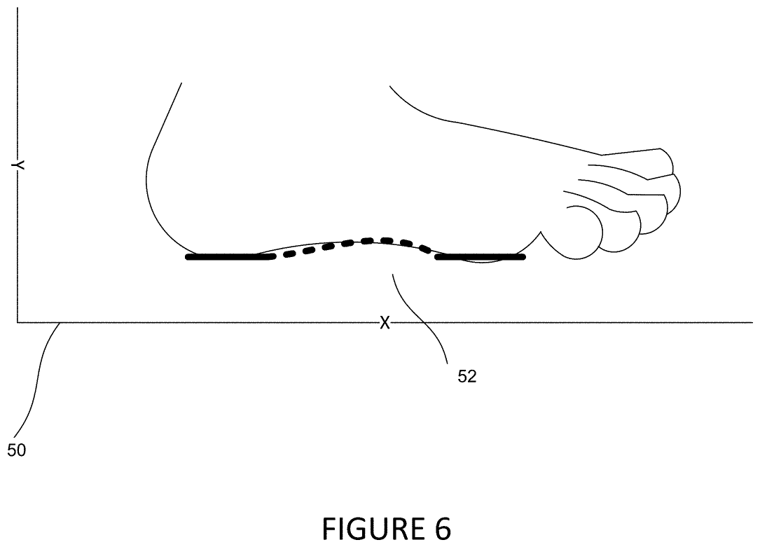

In step 506, the processing server analyzes the image data for body part curvature. The computer vision process seeks an expected curve associated with the body part and with the type of wearable selected. Once the curve is found, in step 508, points are plotted along the curve in a coordinate graph (see FIG. 6). Shown in FIG. 6, the coordinate graph 50 includes an X,Y location along the curve in a collection of points 52. Taken together, the collection of points 52 model the curvature of the body part (here, the arch of a foot).

Notably the analysis of FIG. 5 may be performed using a large trained model (with many thousands or millions of data points). In some embodiments, the FIG. 5 analysis is performed on an application/backend server where the computational complexity or memory footprint of the trained model is of little concern to the overall user experience. The analysis of FIG. 5 may be significantly larger in contrast to the analysis of FIG. 3.

Returning to FIG. 5, in step 510, the processing server packages the data collected by the computer vision process into one or more files for inspection. In some embodiments, in step 512, an administrative user conducts an inspection of the output data from the computer vision process in relation to the acquired images. If there are obvious errors in the data (e.g., the curvature graph is of a shape clearly inconsistent with the curvature of the applicable body part), the generated data is deemed to have failed inspection and can be rejected.

In step 514, a user or an administrator may perform a manual edit of the output data from computer vision reviewed image data. The system transmits a copy of the original images to the user/administrator for editing. The user edits the points and then re-submits the images. The user only provides a reduced selection of points rather than an entire curvature. If no manual edit occurs, in step 516, the image data is processed through an enhancement process to further improve the distinction between foot and background. The enhancement process refers to image retouching to improve line clarity through editing sharpness, resolution, or selective color by changing using individual pixel, group pixel, or vector image edits. The current computer vision reviewed images are discarded, and the computer vision process is run again. If a manual edit occurs, in step 518, the processing server receives updated curvature and/or size specifications.

In step 520, final copies of the size and curvature specifications of the user's subject body part are forwarded to a customization engine of the server application software on the processing server.

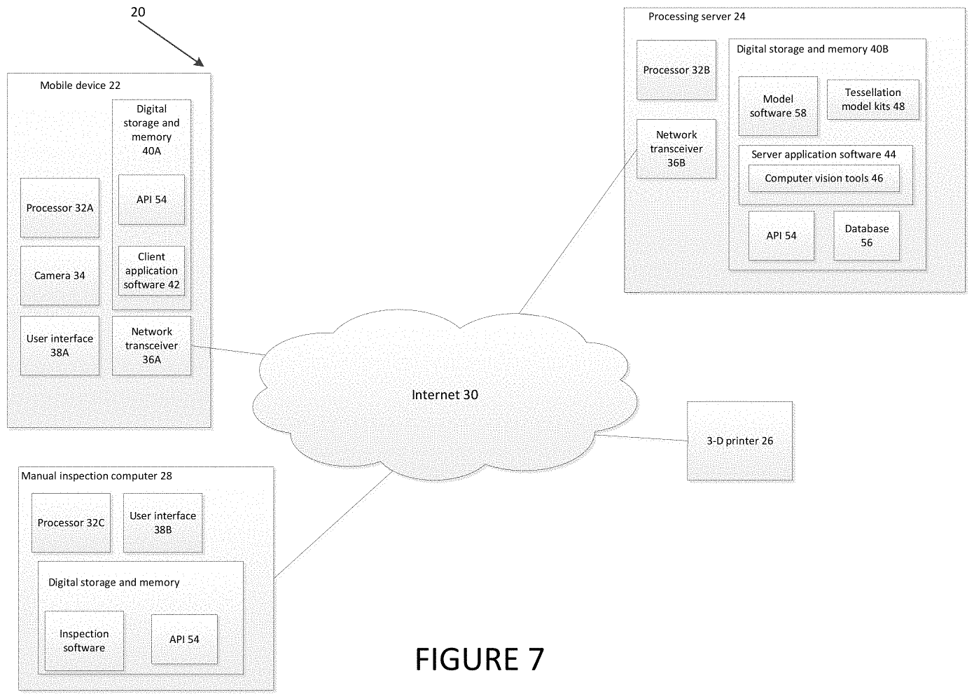

FIG. 7 is a block diagram illustrating an example of a distributed system for the generation of customized 3D printed wearables according to the technique introduced here. Embodiments of the system and method herein may be distributed. The hardware involved may communicate over a network operated by different parties, may be directly connected operating by the same party, or any combination thereof.

For example, in some embodiments, the 3D printer 26 is a network location and outsourced to a contractor for 3D printing. This contrasts with FIG.1 in which the 3D printer 26 is directly connected with the backend processing server 24. Accordingly, instructions are sent to the 3D printer 26 over a network. Additionally, the manual inspection computer 28, operating inspection software 29 may be separate from the backend processing server 24, in both a physical sense and as a decision-making entity. For example, the manual inspection computer 28 may be operated by a doctor of a patient who owns the mobile device 22. In another configuration, the manual inspection computer 28 may be operated by the same corporate entity that operates the processing server 24. In yet another configuration, both the mobile device 22 and the manual inspection computer 28 are operated by a doctor of a patient for whom body images/videos are taken.

The above are merely examples—there are multiple combinations or distributions of actors and hardware. In order to achieve this distribution, embodiments of the system introduced here include a software interface, such as application program interface (“API”) 54, which is used across the distributed hardware to coordinate inputs and outputs in order to reach a 3D-printed and delivered wearable. The API 54 is instantiated on a number of the hardware objects of the system, and ultimately references databases 56 on the processing server 24.

The database 56 stores body images/videos, associated 3D models of body parts, and 3D models of wearable which match the 3D models of the body parts. Each of these images/models are indexed by a user or order number. Devices which instantiate the API 54 may call up images/videos/materials at various points in the wearable generation process, provide input, and observe status of said materials. The API 54 is able to provide query-able status updates for a given wearable order. In this way, the wearable generation has a great degree of transparency and modularity.

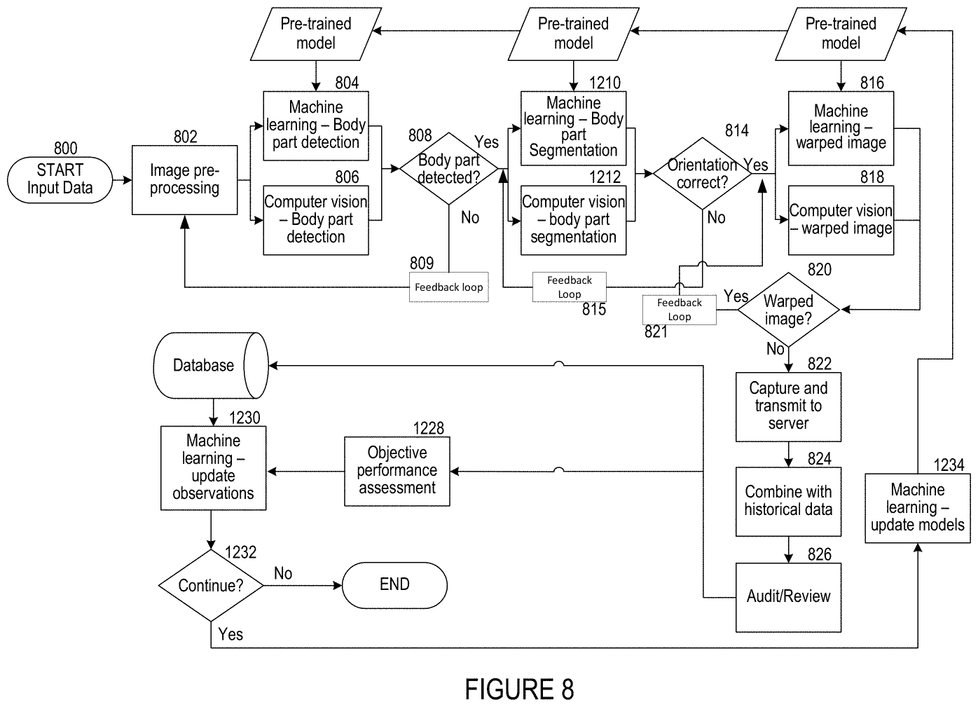

FIG. 8 is a flowchart illustrating wearable generation including concurrent computer vision and machine learning processes. The steps of FIG. 8 are generally performed by the processing power available within the entire system. However, the processing power may be distributed across a number of devices and servers. For example, some steps (or modules) may be performed (or implemented) by a mobile device such as a smart phone while others are performed (or implemented) by a cloud server.

In step 800, input body part image data is provided to the system. The input data may be provided in any of various ways (e.g., through direct upload from smartphone applications, web uploads, API uploads, partner application uploads, etc.). The initial input data are frames used for validation prior to “capture.” Distinctions between frames used for validation and those used for capture are that those used for validation do not necessarily persist on the device or get retained in memory after the validation process. In some embodiments, a further distinction is GUI based; specifically, validation frames are obtained without user input or the activation of a “capture” command/signal, whereas frames used for “capture” may involve user activation. Even if unnecessary, users may feel more comfortable using applications that allow active control over which portions of collected data are actively saved.

In step 802, the viewfinder frame of body part image data begins a pre-processing step prior to capture and transmission.

In steps 804 and 806, the system attempts to detect a body part in the viewfinder frames. This is performed both through computer vision and machine learning. Prior observations and models (e.g., a hidden Markov model) influence the machine learning operation. The detection of a particular body part enables the system to determine the type of product that is most relevant and to validate the viewfinder. In some embodiments, the system performs the body part identification initially to enable the user to select a product type choice (e.g., footwear insole, bra, earphones, gloves, etc.).

In step 808, the system checks whether a body part was, in fact, detected. Where a body part was detected, the method proceeds, whereas where a body part was not detected, the method performs a feedback loop (809). The user interface will additionally signal the user and the user may initiate the method again form the beginning.

In steps 810 and 812, system device performs image segmentation using computer vision and machine learning. Prior observations and models (e.g., a hidden Markov model) influence the machine learning operation. Image segmentation is used to identify particular elements in an image such as differentiating the body part from the background, as well as differentiating different curves and surfaces of the body part.

In step 814, the system determines whether the detected body part is properly in frame and the is viewed from the correct angle. The segmentation data is used to identify components of the body part and whether those components are those required for the current view. Where the correct view is not present, the method enters a feedback loop (815).

In steps 816 and 818, the system performs warp analysis using computer vision and machine learning. Prior observations and models (e.g., a hidden Markov model) influence the machine learning operation. The warp analysis determines if any expected dimensions are not as expected. For example, if a reference object is in frame, what are the dimensions shape of that reference object? Other analysis may include ratios of body part lengths as well.

In step 820, the warp analysis is used to determine whether the viewfinder frame(s) is warped and needs adjustment. If the reference object does not appear as expected, or lengths on the body appear outside of human feasibility (e.g., a foot that is wider than it is long), the frames are warped either via camera angle or object positioning. Based on the manner in which the object is warped (e.g., fails step 820), a feedback loop (821) informs the user how to fix future extracted viewfinder frames.

In step 822, where the viewfinder images are not warped, an image is captured and transmitted to the application server for further processing. In step 824, The system adds the transmitted images to the total observations. In step 826, the system enables users, or administrators to do an audit review. Image data is delivered to model generation and the rest of the 3-D printing process continues separately.

After steps 824-826, the data is added to a database. The process of FIG. 12 continues with an assessment and learning phase. In step 828, the system reviews and performs a performance assessment of the process. In step 830, the machine learning engine of the system updates the observations from the database and the performance assessment. If the process continues, in step 834, the machine leaning models are updated. The updated machine learning models are recycled into use into steps 804, 810, and 816 for subsequent users (e.g., through application updates or API updates).

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. A method comprising:
activating a camera of a mobile device, the camera including an image sensor; and
determining, in the mobile device, whether an image detected in real-time by the camera before receipt of user input for causing image capture includes a representation of a specified body part and is suitable for use in digitally modeling the specified body part, wherein the determining includes generating a measure of image compatibility calculated from image data automatically collected from an output of the image sensor in the absence of any user input for causing image capture, and wherein image data is determined to be suitable for digitally modelling the specified body part based on whether the measure of image compatibility satisfies a specified criterion.

2. The method of claim 1, further comprising:
calculating the image compatibility rating by applying the image data to a computer-generated model trained on a plurality of accepted images of the expected body part, and wherein the image compatibility rating corresponds to a confidence score generated by a comparison to the computer-generated model.

3. The method of claim 1, further comprising:
calculating the image compatibility rating through identification via computer vision of existence of a set of key body features of the expected body part in the image data.

4. The method of claim 1, wherein the image compatibility rating is further based on identification of a reference object in the image data, wherein the reference object has predetermined physical dimensions.

5. The method of claim 4, wherein the image compatibility rating is further based on a positioning of the expected body part in relation to the reference object.

6. The method of claim 1, further comprising:
calculating the image compatibility rating using an orientation angle of the digital camera as identified by a sensor on the mobile device.

7. The method of claim 1, further comprising:
automatically causing the digital camera to generate a captured image in response to an identification that the image data has met the threshold image compatibility rating.

8. The method of claim 7, wherein the image data is temporary image data, the method further comprising:
marking a memory space occupied by the temporary image data as free in response to said causing the digital camera to generate the captured image.

9. The method of claim 7, further comprising:
transmitting, by the mobile device, the captured image to an application server associated with a mobile application.

10. The method of claim 1, wherein calculation of the image compatibility rating is performed by a pre-processing heuristic that requires a smaller memory storage footprint than an image processing process to be used to obtain data to digitally model the expected body part.

11. A mobile device comprising:
a mobile device camera;
a mobile device processor configured to determine whether an image detected in real-time by the mobile device camera before receiving user input to capture includes a representation of a specified body part and is suitable for use in digitally modeling the specified body part, wherein the mobile device processor is further configured to generate a measure of image compatibility calculated from image data automatically collected from the an output of an image sensor of the mobile device camera, and where image data is suitable for digitally modelling the specified body part based on whether the measure of image compatibility satisfies a specified criterion; and
a wireless transceiver and antenna configured to transmit image data obtained by the mobile device camera after receiving user input to capture.

12. The mobile device of claim 11, further comprising:
a mobile device sensor that identifies an orientation of the mobile device camera, and wherein the orientation is used to calculate the measure of image compatibility.

13. The mobile device of claim 11, further comprising:
a memory wherein a memory space occupied by the image detected in real-time is marked as free in response to said receiving user input to capture.

14. The mobile device of claim 13, further comprising:
a display configured to provide feedback to the user including instructions that when followed improve the measure of image compatibility.

15. The mobile device of claim 11, wherein calculation of the measure of image compatibility is performed by a pre-processing heuristic that requires a smaller memory storage footprint than an image processing process to be used to obtain data to digitally model the expected body part.

16. A non-transient computer readable medium containing program instructions, execution of which by a computer causes the computer to perform a method comprising:
extracting, from an image sensor of a digital camera, image data from a real-time video stream;
providing, on a viewfinder, camera adjustment feedback based on an image quality criterion, wherein evaluation according to the image quality criterion determines whether a computer vision analysis of a captured image is capable of determining true-to-life dimensions for a subject object of the captured image; and
capturing, by the digital camera, an image.

17. The computer readable medium of claim 16, further comprising:
evaluating the image quality criterion by applying the image data to a computer-generated model trained on a plurality of accepted images of the subject object, and wherein the image quality criterion corresponds to a confidence score generated by a comparison to the computer-generated model.

18. The computer readable medium of claim 16, further comprising:
evaluating the image quality criterion through identification via computer vision of existence of a set of key features of the subject object in the image data.

19. The computer readable medium of claim 16, wherein the image quality criterion is further based on identification of a reference object in the image data, wherein the reference object has predetermined physical dimensions.

20. The computer readable medium of claim 16, further comprising:
evaluating the image quality criterion through an orientation angle of the digital camera as identified by a sensor coupled to the digital camera.
